(19) United States
(12) Patent Application Publication
(10) Pub. No.: US 2015/0254477 A1
(43) Pub. Date: Sep. 10, 2015

(54) ENCRYPTION/DECRYPTION SYSTEM WHICH PERFORMS ENCRYPTION/DECRYPTION USING REGISTER VALUES, CONTROL METHOD THEREFOR, AND STORAGE MEDIUM

(71) Applicant: CANON KABUSHIKI KAISHA, Tokyo (JP)

(72) Inventor: Akihiro Matsumoto, Kawasaki-shi (JP)

(21) Appl. No.: 14/637,450

(22) Filed: Mar. 4, 2015

(30) Foreign Application Priority Data
Mar. 6, 2014 (JP) 2014-043834

(51) Int. Cl. G06F 21/72; H04L 9/08

(52) U.S. Cl. CPC G06F 21/72; H04L 9/0861; G06F 21/725

(57) ABSTRACT

An encryption/decryption system which is capable of preventing encrypted data from being easily decrypted. A program for carrying out an encryption process or a decryption process on data sent and received to and from a host apparatus is stored in encrypted form. A key for decrypting the stored program is generated in response to startup of the encryption/decryption system. The stored program is decrypted using the generated key, and the decrypted program is executed.

### BACKGROUND OF THE INVENTION

1. Field of the Invention

The present invention relates to an encryption/decryption system, a control method therefor, and a storage medium.

2. Description of the Related Art

Conventional printing apparatuses have an encrypting function and a decrypting function for enhanced security. With the encrypting function, data stored in a storage device such as an HDD which the printing apparatuses have is encrypted, and with the decrypting function, the encrypted data is decrypted using a so-called encryption key.

In governments in some countries including Japan and the U.S. and security-aware corporations, the printing apparatuses mentioned above are required to obtain certification from a third-party institution based on “Japan Cryptographic Module Validation Program” which is one of product certification systems, and specifically, required to have security levels 2 or higher approval under this certification program.

The encrypting function is offered by an IC chip, and from the standpoint of enhancing robustness in terms of security, is more preferably offered by an SiP (System in a Package) in which a nonvolatile memory die, in which secret information such as a encryption key, an encryption program, and so on are stored, and an encryption logic die are sealed in a package.

In general, an IC chip has an input-output IF for use in input and output of data, a debug IF for use in failure analysis, and a memory IF for use in storing an encryption program in a nonvolatile memory inside the IC chip, and in some cases, an analysis of the interior of the IC chip is carried out by way of the debug IF or the memory IF.

In order that the encrypting function can be offered by an IC chip, and security levels 2 or higher certification under “Japan Cryptographic Module Validation Program” can be obtained, information included in the IC chip has to be prevented from being analyzed even when an access to a debug IF or a memory IF is made. To deal with this, there is a method in which part or all of secret information and an encryption program stored in a nonvolatile memory are subjected to encryption.

Secret information and an encryption program stored in a nonvolatile memory are encrypted using, for example, the AES (advanced encryption standard) which is a common key cryptosystem, but a encryption key for encrypted secret information and an encryption program is reproduced sometimes based on information obtained by a third party through access to a debug IF or a memory IF. Thus, in order to prevent a encryption key for encrypted secret information and an encryption program from being reproduced easily by a third party, data is encrypted using random numbers obtained by inputting a encryption key generated by a encryption key generation unit which an encryption apparatus has and an initial input value set in plain text in a register to a random number generation circuit (see, for example, Japanese Laid-Open Patent Publication (Kokai) No. H10-22994).

However, an initial input value in the register is set in plain text, and hence when the initial input value is stolen, a encryption key is reproduced, causing encrypted data to be decrypted with ease.

### SUMMARY OF THE INVENTION

The present invention provides an encryption/decryption system and a control method therefor which are capable of preventing encrypted data from being easily decrypted, as well as a storage medium.

Accordingly, a first aspect of the present invention provides an encryption/decryption system which sends and receives data to and from a host apparatus, comprising a storage unit configured to store, in encrypted form, a program for carrying out an encryption process or a decryption process on data sent and received to and from the host apparatus, a key generation unit configured to generate a key for decrypting the stored program in response to startup of the encryption/decryption system, a decryption unit configured to decrypt the stored program using the key generated by the key generation unit, and an execution unit configured to execute the decrypted program.

Accordingly, a second aspect of the present invention provides a control method for an encryption/decryption system which sends and receives data to and from a host apparatus, comprising a storage step of storing, in encrypted form, a program for carrying out an encryption process or a decryption process on data sent and received to and from the host apparatus, a key generation step of generating a key for decrypting the stored program in response to startup of the encryption/decryption system, a decryption step of decrypting the stored program using the key generated in the key generation step, and an execution step of executing the decrypted program.

Accordingly, a third aspect of the present invention provides a non-transitory computer-readable storage medium storing a program for causing a computer to execute a control method for an encryption/decryption system which sends and receives data to and from a host apparatus, the control method comprising a storage step of storing, in encrypted form, a program for carrying out an encryption process or a decryption process on data sent and received to and from the host apparatus, a key generation step of generating a key for decrypting the stored program in response to startup of the encryption/decryption system, a decryption step of decrypting the stored program using the key generated in the key generation step, and an execution step of executing the decrypted program.

According to the present invention, the program for carrying out the encryption process or the decryption process is stored, and the key for decrypting the program is generated in response to startup of the encryption/decryption system. The encrypted program is decrypted using the generated key to carry out the encryption process or the decryption process. As a result, encrypted data is prevented from being decrypted easily.

Further features of the present invention will become apparent from the following description of exemplary embodiments (with reference to the attached drawings).

### BRIEF DESCRIPTION OF THE DRAWINGS

FIG. 1 is a block diagram schematically showing an arrangement of an image forming system having an encryption processing apparatus according to an embodiment of the present invention.

FIG. 2 is a block diagram showing a connecting state of an encryption IC in FIG. 1.

FIG. 3 is a block diagram schematically showing an internal arrangement of the encryption IC in FIG. 2.

FIG. 4 is a diagram showing main data stored in a flash memory and a RAM in FIG. 3.

FIG. 5 is a diagram useful in explaining how to generate the information a which is required to generate a secret information encryption key in FIG. 4.

FIG. 6A is a diagram showing a seed value which is used to generate the secret information encryption key in FIG. 4, and FIG. 6B is a diagram useful in explaining how to generate the secret information encryption key using the seed value in FIG. 6A.

FIG. 7 is a view showing bit strings in X1 which is information a generated at a time t1 in FIG. 6B.

FIG. 8 is a flowchart showing the procedure of an encryption process in which a data encryption program and secret information in FIG. 4 are encrypted.

FIGS. 9A and 9B are flowcharts showing the procedure of a program execution process in which a secret information encryption program and the data encryption program in FIG. 4 are executed.

### DESCRIPTION OF THE EMBODIMENTS

The present invention will now be described with reference to the drawings showing an embodiment thereof.

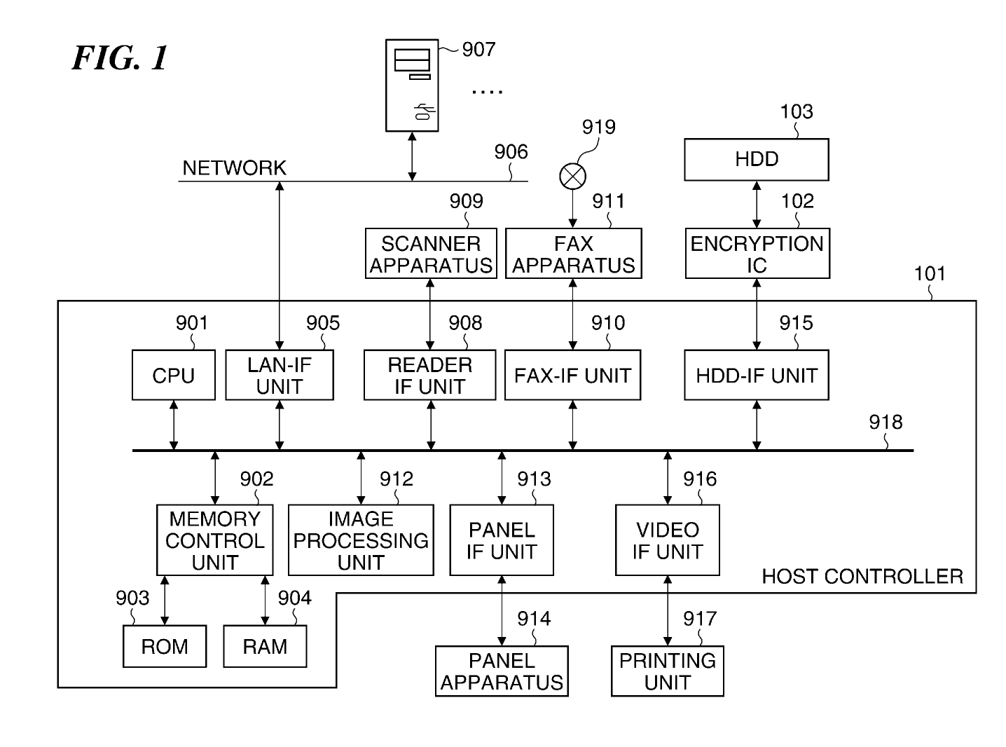

FIG. 1 is a block diagram schematically showing an arrangement of an image forming system having an encryption processing apparatus according to an embodiment of the present invention.

The image forming system in FIG. 1 has a host controller 101 and a host computer 907, which are connected to each other via a network 906. The host controller 101 has a CPU 901, a memory control unit 902, a LAN-IF unit 905, a reader IF unit 908, a FAX-IF unit 910, an image processing unit 912, a panel IF unit 913, an HDD-IF unit 915, and a video IF unit 916, and they are connected to one another via a bus 918.

The host controller 101 also has a ROM 903 and a RAM 904, which are connected to the memory control unit 902. The network 906, a scanner apparatus 909, a FAX apparatus 911, a panel apparatus 914, an encryption IC 102, and a printing unit 917 are connected to the LAN-IF unit 905, the reader IF unit 908, the FAX-IF unit 910, the panel IF unit 913, the HDD-IF unit 915, and the video IF unit 916, respectively, and the FAX apparatus 911 is connected to a public telephone line 919. An HDD 103 is connected to the encryption IC 102.

The host controller 101 is provided in, for example, an MFP (multi-function printer). The CPU 901 provides system control and performs arithmetic processing, and the memory control unit 902 controls input and output to and from various memory device and control DMA (direct memory access).

The ROM 903 stores a starting program, various processing programs, control parameters, and so on. The RAM 904 is a write-dedicated memory typified by a DDR (double data rate) memory.

The image processing unit 912 carries out various types of image processing on image data obtained via the LAN-IF unit 905, the reader IF unit 908, and the FAX-IF unit 910. The scanner apparatus 909 reads an original and converts it into image data. The FAX apparatus 911 controls communication and sends and receives data via the public telephone line 919. The panel apparatus 914 is a user interface, and a user operates buttons and others displayed on a liquid crystal display via the panel apparatus 914. Through such operation, various settings on the scanner apparatus 909 and others connected to the host controller 101 are configured. The printing unit 917 is a printer having a printing apparatus main body, a sheet-feeding unit, and a sheet-discharging unit and prints print data on sheets according to command information mainly from the video IF unit 916.

The encryption IC 102 performs encryption processing and decryption processing on data sent and received via a SATA-IF 104, to be described later, which the encryption IC 102 has, and so on. The HDD 103 is a nonvolatile mass-storage device, in which image data and various programs are stored, and has a data area (not shown) which is used as a temporary work area and a system area (not shown) in which, for example, version information on the HDD 103 is stored.

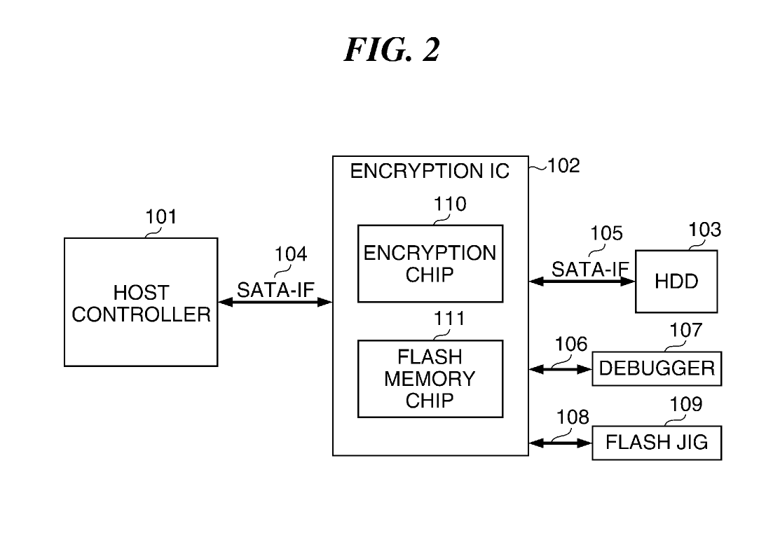

FIG. 2 is a block diagram showing a connecting state of the encryption IC 102 in FIG. 1.

Referring to FIG. 2, the encryption IC 102 is connected to the host controller 101 and the HD 103 via SATA-IFs 104 and 105, respectively, which are IFs conforming with SATA (serial advance technology attachment) standards for connecting with external storage devices. The encryption IC 102 is connected to a debugger 107 and a flash jig 109 via a debug IF 106 and a flash memory IF 108, respectively (encryption/decryption system). The debugger 107 is for use in software development and verification in the event of failure. The flash jig 109 is a jig for use in connecting a flash memory chip 111, to be described later. It should be noted that the debugger 107 and the flash jig 109 are not used when the encryption IC 102 is normally started.

The encryption IC 102 is configured as an SiP in which an encryption chip 110 and the flash memory chip 111 are enclosed in a single package. The encryption chip 110 performs encryption processing on, for example, data stored in the HDD 103. The flash memory chip 111 stores various data. The flash memory chip 111 should not necessarily be incorporated in the encryption IC 102 but may be externally added to the encryption IC 102.

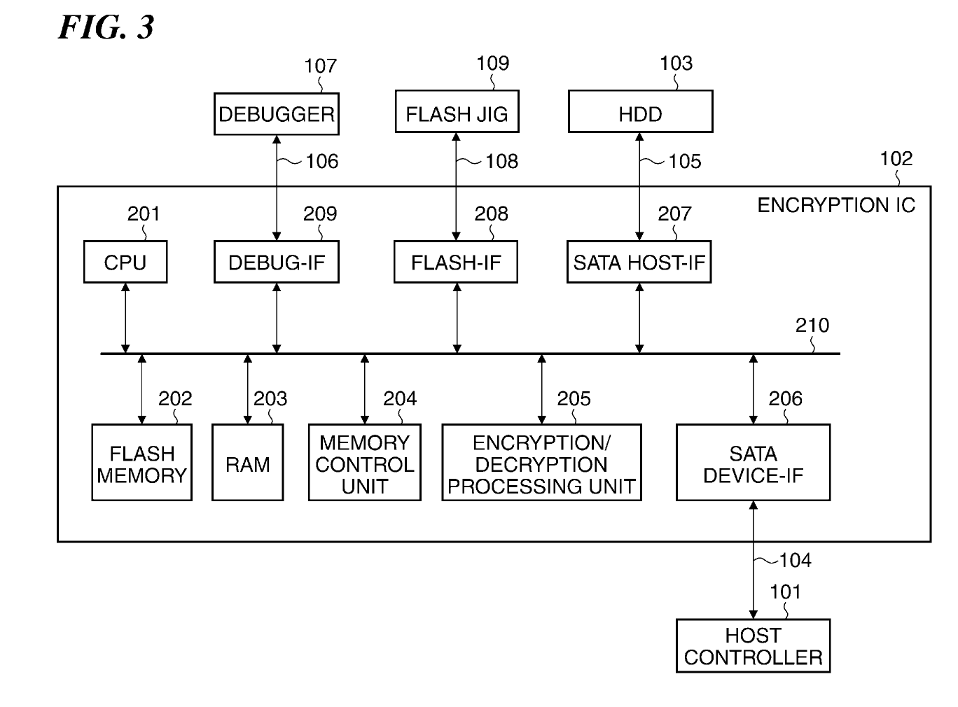

FIG. 3 is a block diagram schematically showing an internal arrangement of the encryption IC 102 in FIG. 2.

The encryption IC 102 in FIG. 3 has a CPU 201, a flash memory 202, a RAM 203, a memory control unit 204, an encryption/decryption processing unit 205, a SATA device-IF 206, a SATA host-IF 207, a flash-IF 208, and a debug-IF 209, and they are connected to one another via a bus 210. The encryption IC 102 is connected to the host controller 101, the HDD 103, the flash jig 109, and the debugger 107 via the SATA device-IF 206, the SATA host-IF 207, the flash-IF 208, and the debug-IF 209, respectively.

The CPU 201 executes such programs as an encryption program, a pseudorandom program, and a SATA-IF control program, which are stored in the flash memory 202 and the RAM 203.

The flash memory 202 is a nonvolatile memory, in which various programs, various control parameters, secret information for encryption, and so on are stored. The RAM 203 is a volatile memory, which is used as a program execution area, a temporary work area, a storage area for a generated encryption key, and so on. The memory control unit 204 controls input and output of data to and from the flash memory 202 and the RAM 203. The encryption/decryption processing unit 205 performs encryption processing and decryption processing on data using, for example, the AES (advanced encryption standard) which is a common key cryptosystem.

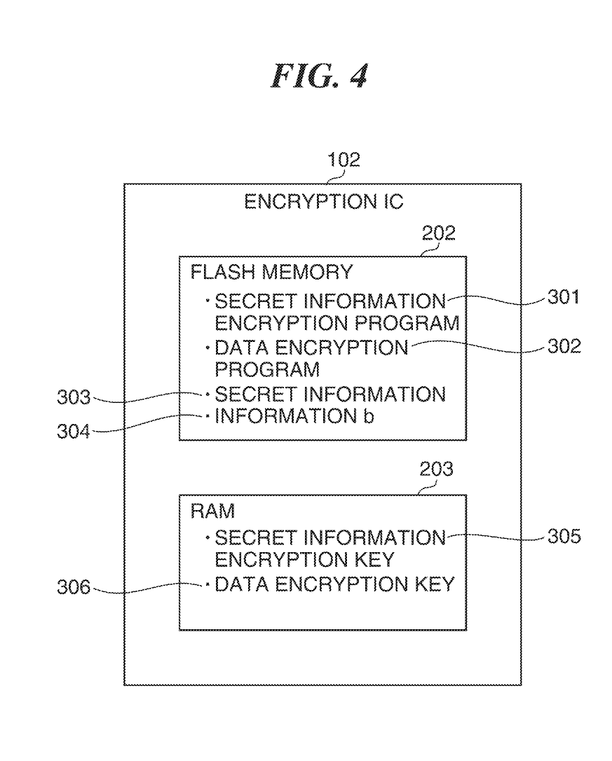

FIG. 4 is a diagram showing main data stored in the flash memory 202 and the RAM 203 in FIG. 3.

Referring to FIG. 4, the flash memory 202 stores a secret information encryption program 301, a data encryption program 302, secret information 303, and information b 304, and the RAM 203 stores a secret information encryption key 305 and a data encryption key 306.

The secret information encryption program 301 performs encryption/decryption processing on part or all of the data encryption program 302 and the secret information 303 using, for example, the AES and generates the secret information encryption key 305 on the RAM 203 using the information b 304 and information a 410, to be described later. The data encryption program 302 performs encryption/decryption processing on data sent and received between the host controller 101 and the HDD 103 via the SATA-IFs 104 and 105 using, for example, the AES and generates the data encryption key 306 on the RAM 203 using the secret information 303.

The secret information 303 is authentication information for use in making the encryption IC 102 available or highly-confidential and important information for use in generating the data encryption key 306 and is received from the host controller 101 connected to the encryption IC 102 via the SATA-IF 104.

The information b 304 is comprised of a bit value and allowed to be combined with the information a 410, to be described later. The information b 304 is received from the host controller 101 and comprised of a bit value which varies according to, for example, the individual host controller 101 as a receiving side or the timing of reception from the host controller 101. The secret information encryption program 301 and the information b 304 are stored in plain text in the flash memory 202, and the data encryption program 302 and the secret information 303 are stored in encrypted form in the flash memory 202.

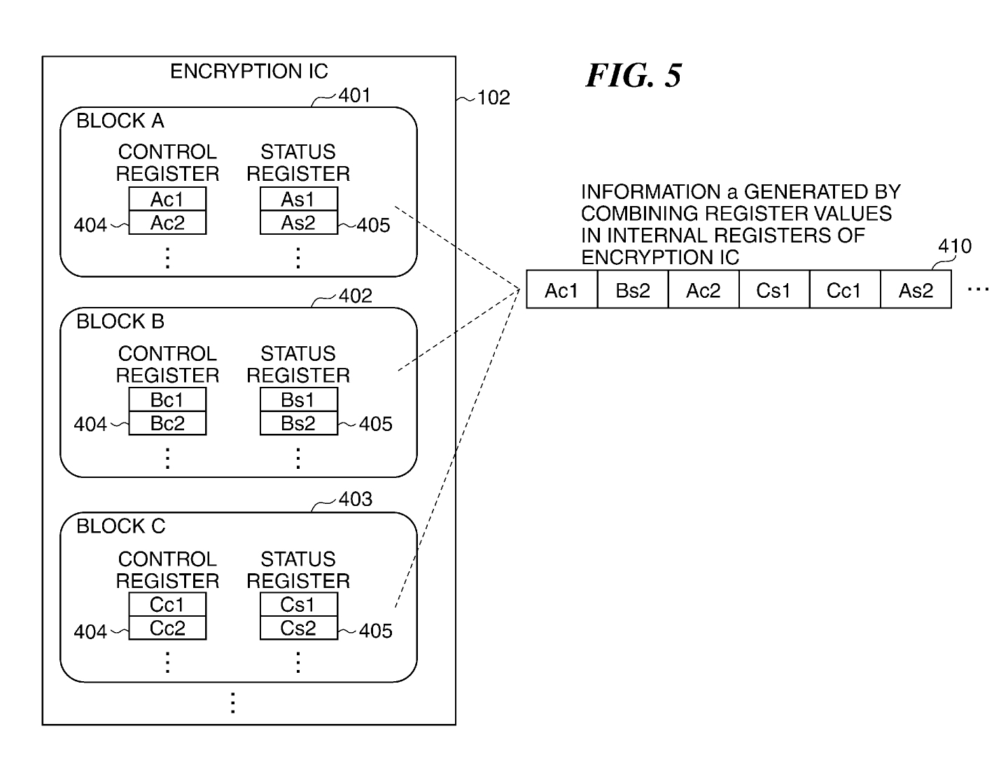

FIG. 5 is a diagram useful in explaining how to generate the information a 410 which is required to generate the secret information encryption key 305 in FIG. 4.

Referring to FIG. 5, the encryption IC 102 has a plurality of functional blocks consisting of a block A 401, a block B 402, and a block C 403, and each of these functional blocks has a control register 404 and a status register 405, each of which is comprised of register values comprised of bit strings.

The control register 404 is a register for use in controlling hardware modules, and the status register 405 is a register which indicates arithmetic conditions of the CPU 201. Namely, the register values constituting the status register 405 vary with arithmetic conditions of the CPU 201, and for example, the register values constituting the status register 405 vary according to how the encryption IC is started.

The information a 410 is generated by, for example, combining register values Ac1, Ac2, and Cc1 selected from the resister values in the control register 404 and register values As2, Bs2, and Cs1 selected from the register values in the status register 405 in a certain period of time (information value generating unit). As described above, the register values in the status register 405 vary with arithmetic conditions of the CPU 201. In other words, the register values in the status register 405 vary with time, and hence the information a 410 including the register values in the status register 405 also varies according to the time at which the information a 410 is generated.

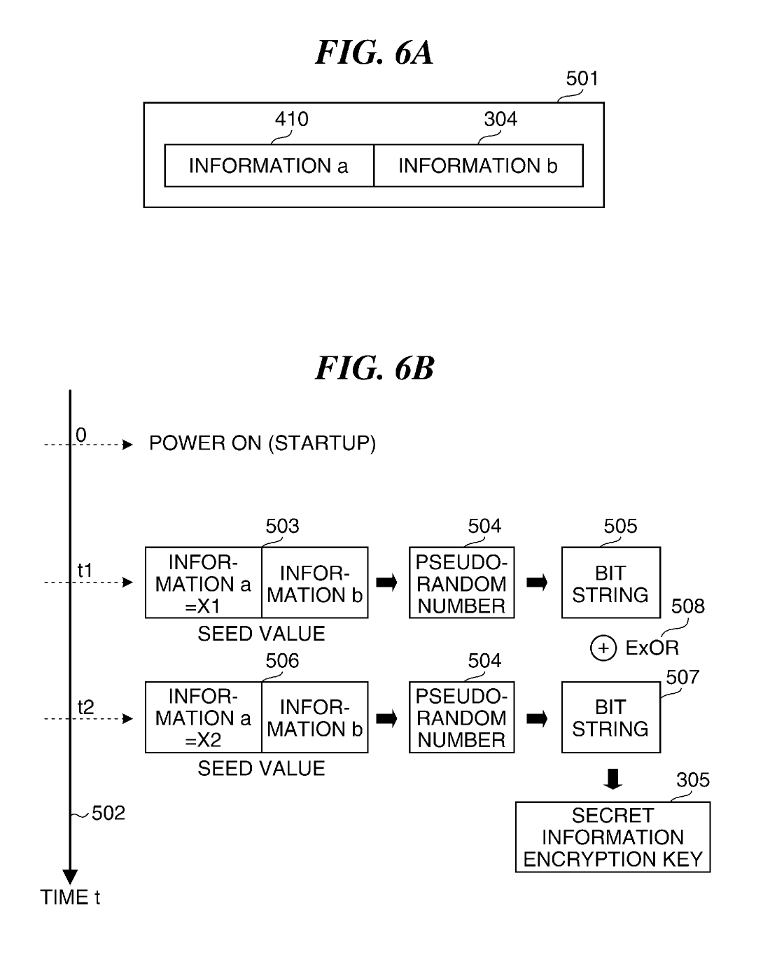

FIG. 6A is a diagram showing a seed value for use in generating the secret information encryption key 305 in FIG. 4.

Referring to FIG. 6A, a seed value 501 is obtained by combining the information a 410 and the information b 304 together.

FIG. 6B is a diagram useful in explaining how to generate the secret information encryption key 305 using the seed value 501 in FIG. 6A.

Referring to FIG. 6B, a time axis 502 indicates the lapse of time where the power to the encryption IC 102 is turned on at a time t=0. For example, at a time t1, X1 which is the information a 410 generated at the time t1 and the information b 304 are combined with each other to obtain a seed value 503, and the obtained seed value 503 is input to a pseudorandom module 504 to obtain a bit string 505 (pseudo-randomization). At a time t2, X2 which is the information a 410 generated at the time t2 and the information b 304 are combined with each other to obtain a seed value 506, and the obtained seed value 506 is input to the pseudorandom module 504 to obtain a bit string 507. After that, an exclusive-OR operation (ExOR) 508 is performed using the bit strings 505 and 507 to generate the secret information encryption key 305 (encryption key generation unit).

It should be noted that the seed values 503 and 506 should not necessarily be obtained by combining the information b 304, but the information a 410 alone may constitute the seed values 503 and 506. However, when the secret information encryption key 305 is generated without combining the information b 304 in a case where encryption IC chips (hereafter referred to as “production model encryption IC chips”) distributed in large numbers on the market are used, both X1 and X2 which are the information a 410 at the time t1 and the time t2 are generated from the same register value in both the production model encryption IC chips, and hence the obtained secret information encryption keys 305 are the same, and the secret information encryption keys 305 may be reproduced with ease.

Accordingly, for example, by combining the information b 304 comprised of a bit value varying with the individual host controller 101, the secret information encryption keys 305 for individual encryption IC chips are generated, so that the secret information encryption keys 305 can be prevented from being the same when production model encryption IC chips are used. This raises security level.

When the secret information encryption key 305 is generated from the information a 410 and the information b 304, such nullification (zeroization) of the secret information encryption key 305 such that only the information b 304 is changed is allowed to be performed. When the information b 304 is changed, the secret information encryption key 305 generated before the change of the information b 304 cannot be used, and hence even if, for example, the secret information 303 encrypted using the secret information encryption key 305 is discarded, the encrypted secret information 303 will never be decrypted after the change of the information b 304, and this further raises security level.

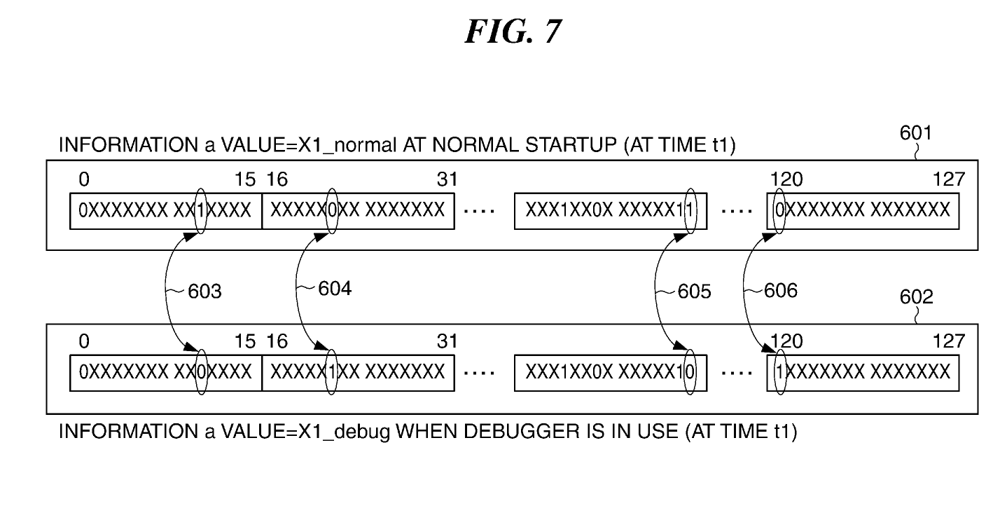

FIG. 7 is a view showing bit strings in X1 which is the information a 410 generated at the time t1 in FIG. 6B. In the figure, X1_normal 601 corresponds to the information a 410 which is generated when the encryption IC 102 is normally started, and X1_debug 602 corresponds to the information a 410 which is generated when the encryption IC 102 is started using the debugger 107.

As described above, since the register values constituting the status register 405 vary according to how the encryption IC 102 is started in a case where there are two or more ways to start the encryption IC 102, the bit values constituting the information a 410, which includes the register values in the status register 405, as well varies according to how the encryption IC 102 is started. For example, as shown in FIG. 7, X1_normal 601 and X1_debug 602 have differing bits 603 to 606.

Namely, the information a 410 can be changed by changing the way to start the encryption IC 102, and hence the secret information encryption key 305 generated by combining the information a 410 can be changed. This raises the security level of the secret information encryption key 305.

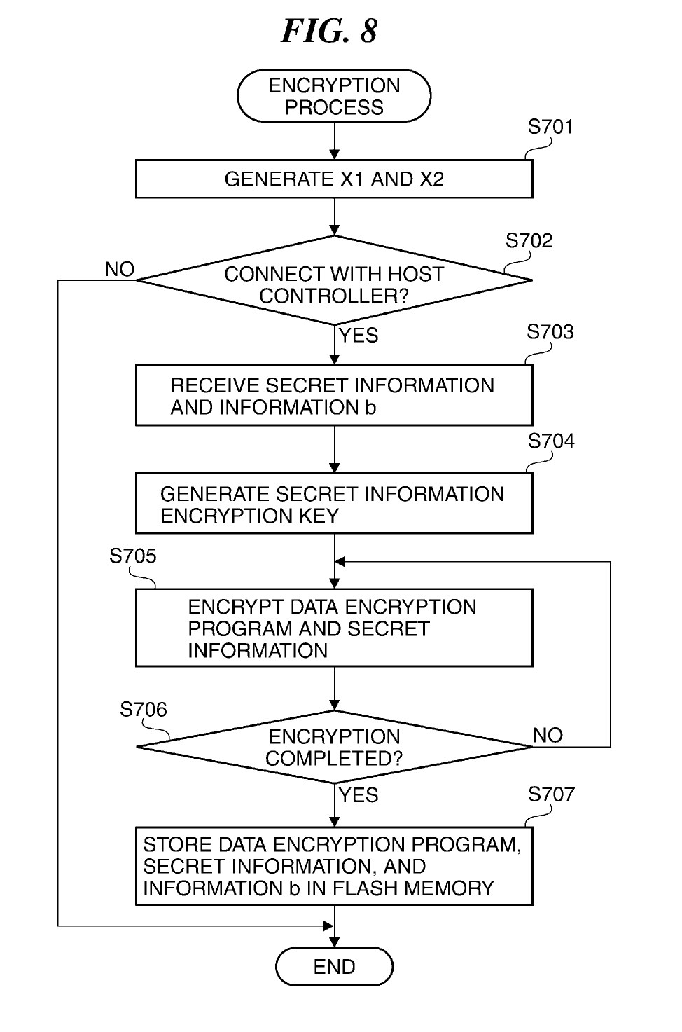

FIG. 8 is a flowchart showing the procedure of an encryption process in which the data encryption program 302 and the secret information 303 in FIG. 4 are encrypted.

The encryption process in FIG. 8 is carried out by the CPU 201 which the encryption IC 102 has.

Referring to FIG. 8, the CPU 201 generates X1 and X2, which are the information a 410 at the times t1 and t2, using the generation method in FIG. 5 (step S701) and determines whether or not the encryption IC 102 is connected to the host controller 101 (step S702).

As a result of the determination in the step S702, when the encryption IC 102 is connected to the host controller 101 (YES in the step S702), the CPU 201 receives the secret information 303 and the information b 304 from the host controller 101 (step S703).

The CPU 201 then inputs the seed value 503, which is obtained by combining X1 and the information b 304 together, to the pseudorandom module 504 to obtain the bit string 505, inputs the seed value 506, which is obtained by combining X2 and the information b 304 together, to the pseudorandom module 504 to obtain the bit string 507, and performs the exclusive-OR operation (ExOR) 508 using the obtained bit strings 505 and 507 to generate the secret information encryption key 305 (step S704).

The CPU 201 then performs encryption processing on the data encryption program 302 and secret information 303 using the generated secret information encryption key 305 (step S705) and determines whether or not the encryption processing has been completed (step S706).

As a result of the determination in the step S706, when the encryption processing has not yet been completed (NO in the step S706), the process returns to the step S705, and when the encryption processing has been completed (YES in the step S706), the CPU 201 stores the information b 304, which has been used to generate the encrypted data encryption program 302, the secret information 303, and the secret information encryption key 305, in the flash memory 202 (step S707) and terminates the present process.

On the other hand, as a result of the determination in the step S702, when the encryption IC 102 is not connected to the host controller 101 (NO in the step S702), the CPU 201 immediately terminates the present process without receiving the secret information 303 and the information b 304 from the host controller 101.

According to the encryption process in FIG. 8, since X1 and X2 which are the information a 410 generated using register values selected from the plurality of register values in the status register 405 varying with time are used (step S701) to generate the secret information encryption key 305 (step S704), it is difficult for a third party who starts the encryption IC 102 at a time different from the times t1 and t2 to generate the information a 410 using the same register values, and this makes reproduction of the secret information encryption key 305 difficult. As a result, the encrypted data encryption program 302 and secret information 303 are prevented from being easily decrypted by a third party.

Moreover, according to the encryption process in FIG. 8, the secret information encryption key 305 is generated by combining the information a 410 with the information b 304 (step S704), but a bit value constituting the information b 304 varies according to, for example, the individual host controller 101, and it is thus possible to generate the secret information encryption key 305 unique to an encryption IC chip, making reproduction of the secret information encryption key 305 more difficult and thus further raising security level.

Further, according to the encryption process in FIG. 8, since the secret information encryption key 305 is generated by combining the information a 410 with the information b 304 (step S704), it is possible to nullify (zeroizes) the secret information encryption key 305 and further raise security level.

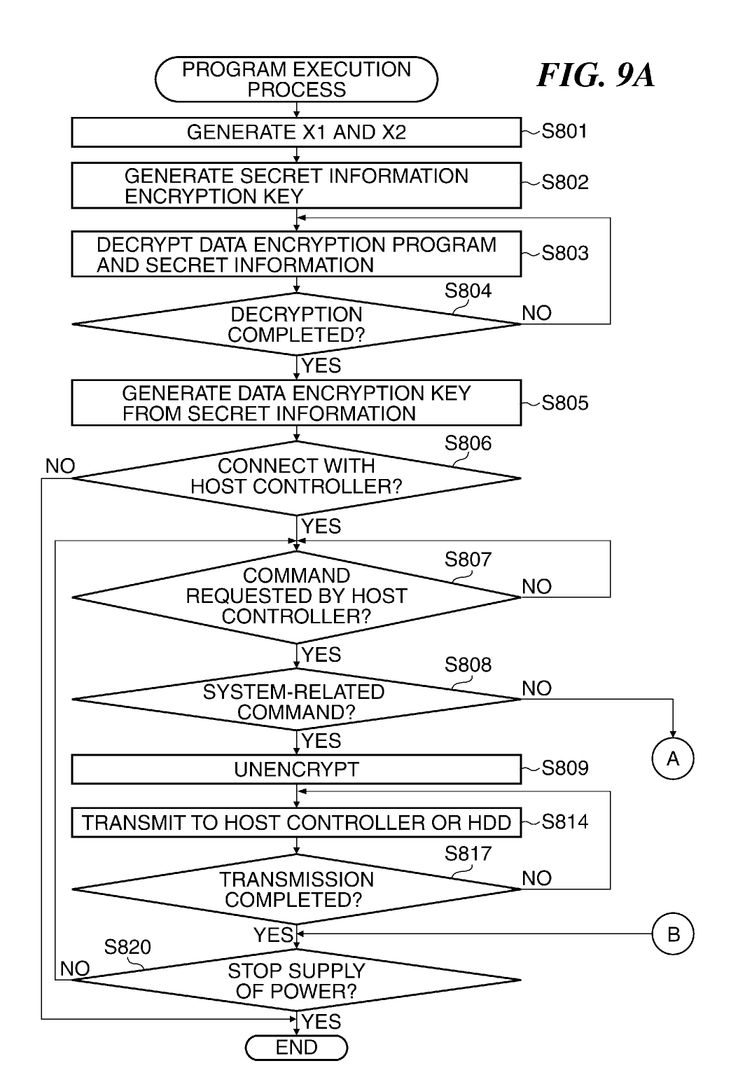

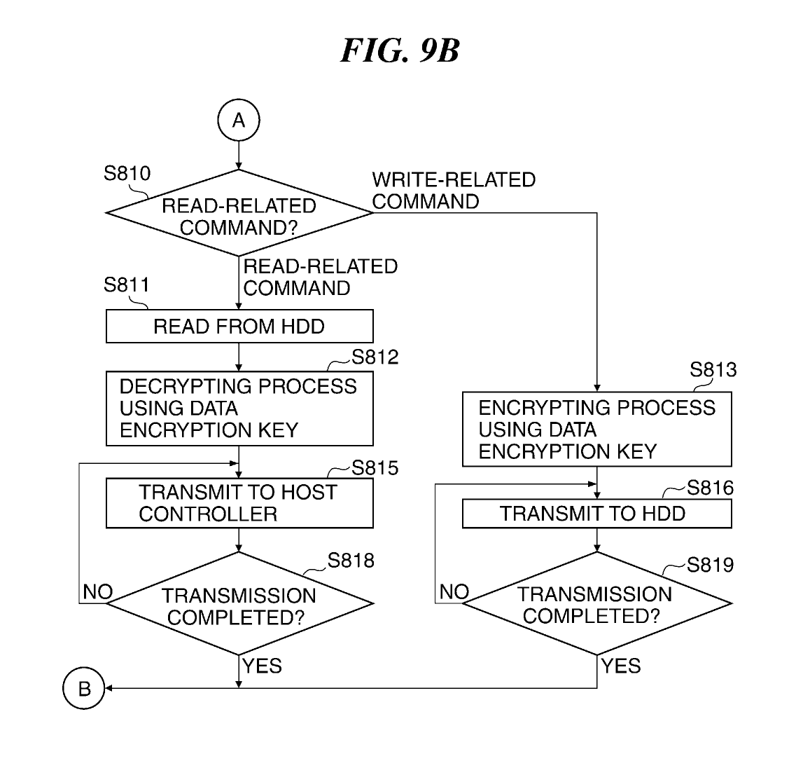

FIGS. 9A and 9B are flowcharts showing the procedure of a program execution process in which the secret information encryption program 301 and the data encryption program 302 in FIG. 4 are executed.

The program execution process in FIGS. 9A and 9B is carried out by the CPU 201 which the encryption IC 102 has.

Referring to FIG. 9A, first, the CPU 201 generates each of X1 and X2 which are the information a 410 at the times t1 and t2 using the generation method in FIG. 5 (step S801).

Next, the CPU 201 obtains the bit string 505 by inputting the seed value 503, which is obtained by combining X1 and the information b 304 stored in the flash memory 202, to the pseudorandom module 504, obtains the bit string 507 by inputting the seed value 506, which is obtained by combining X2 and the information b 304 stored in the flash memory 202 to the pseudorandom module 504, and performs the exclusive-OR operation (ExOR) 508 using the obtained bit strings 505 and 507 to generate the secret information encryption key 305 (step S802).

The register values in the status register 405 represent the same values at the same time, and hence X1 and X2 generated in the step S701 and the step S801 which are common in terms of time are the same, and the secret information encryption keys 305 generated in the step S704 and the step S802 are also the same. Thus, the data encryption program 302 and secret information 303 encrypted using the secret information encryption key 305 generated in the step S704 are allowed to be decrypted using the secret information encryption key 305 generated in the step S802.

Then, the CPU 201 carries out decryption processing on the data encryption program 302 and the secret information 303 (both of them have been encrypted using the secret information encryption key 305 generated in the step S704) using the secret information encryption key 305 generated in the step S802 and expands the decrypted data encryption program 302 and secret information 303 on the RAM 203 (step S803) and determines whether or not the decryption processing has been completed (step S804).

As a result of the determination in the step S804, when the decryption processing has not been completed (NO in the step S804), the process returns to the step S803, and when the decryption processing has been completed (YES in the step S804), the CPU 201 generates the data encryption key 306 using the secret information 303 decrypted and expanded on the RAM 203 (step S805) and determines whether or not to establish connection with the host controller 101 (step S806).

As a result of the determination in the step S806, when connection with the host controller 101 is to be established (YES in the step S806), communication between the host controller 101 and the HDD 103 is established, so that commands from the host controller 101 can be received.

On the other hand, as a result of the determination in the step S806, when connection with the host controller 101 is not to be established (NO in the step S806), the present process is immediately terminated irrespective of whether or not there is a command request from the host controller 101.

After that, the CPU 201 determines whether or not a command has been requested by the host controller 101 (step S807), and when a command has been requested by the host controller 101 (YES in the step S807), the CPU 201 determines whether or not the requested command is a system-related command to read system information from the system area of the HDD 103 or a system-related command to write system information in the system area of the HDD 103 (step S808).

As a result of the determination in the step S808, when the requested command is the system-related command (YES in the step S808), the CPU 201 performs transmission of system information to the host controller 101 or the HDD 103 (step S814) in plaintext as it is without encrypting the system information (unencryption) (step S809) until the transmission is completed (YES in step S817) because the system information is in plain text and the necessity to encrypt it is not great.

On the other hand, as a result of the determination in the step S808, when the requested command is not the system-related command (NO in the step S808), the CPU 201 determines whether the requested command is a read-related command to read data information from the data area of the HDD 103 or a write-related command to write data information in the data area of the HDD 103 (step S810).

As a result of the determination in the step S810, when the requested command is the read-related command, the CPU 201 reads ciphertext data from the HDD 103 (step S811), decrypts the ciphertext data using the data encryption key 306 (step S812), and performs transmission of the decrypted data to the host controller 101 (step S815) until the transmission is completed (YES in step S818).

As a result of the determination in the step S808, when the requested command is the write-related command, the CPU 201 encrypts data received from the host controller 101 using the data encryption key 306 (step S813), and performs transmission of the encrypted data to the HDD 103 (step S816) until the transmission is completed (YES in step S819).

When the supply of power to the encryption IC 102 is stopped (YES in step S820) after the transmission is completed (YES in the step S817, YES in the step S818, or YES in the step S819), the present process is brought to an end, and when the supply of power to the encryption IC 102 is not stopped (NO in the step S820), the CPU 201 carries out the processes in the step S807 and the subsequent steps again.

According to the program execution process in FIGS. 9A and 9B, as with the encryption process in FIG. 8, since X1 and X2 which are the information a 410 generated using register values selected from the plurality of register values in the status register 405 varying with time are used (step S801) to generate the secret information encryption key 305 (step S802), and the data encryption program 302 and the secret information 303 are subjected to decryption processing using the secret information encryption key 305 (step S803). As described above, it is difficult for a third party who activates the encryption IC 102 at a time different from the times t1 and t2 to generate the information a 410 using the same register values, and this makes reproduction of the secret information encryption key 305 difficult. As a result, the encrypted secret information 303 is prevented from being decrypted with ease.

Moreover, according to the program execution process in FIGS. 9A and 9B, since the data encryption key 306 is not generated unless the secret information 303 is decrypted (step S805), encrypted data encrypted using the data encryption key 306 stored in the HDD 103 is prevented from being analyzed by a third party.

It should be noted that the secret information encryption key 305 may be generated at the time when the encryption IC 102 is started (t1=t2=0). Namely, since the secret information encryption key 305 for use in decrypting the data encryption program 302 and the secret information 303 is generated in response to the activation of the encryption IC 102 (steps S801 to S803), the possibility of a third party decrypting the data encryption program 302 and the secret information 303 between encryption and decryption of the data encryption program 302 and the secret information 303.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-043834, filed Mar. 6, 2014, which is hereby incorporated by reference herein in its entirety.

What is claimed is:

1. An encryption/decryption system which sends and receives data to and from a host apparatus, comprising:
a storage unit configured to store, in encrypted form, a program for carrying out an encryption process or a decryption process on data sent and received to and from the host apparatus;
a key generation unit configured to generate a key for decrypting the stored program in response to startup of the encryption/decryption system;
a decryption unit configured to decrypt the stored program using the key generated by said key generation unit; and
an execution unit configured to execute the decrypted program.

2. The encryption/decryption system according to claim 1, further comprising:
a first register configured to comprise at least one register value;
a second register configured to comprise at least one register value;
a selection unit configured to select at least one first register value from the at least one register value constituting said first register and select at least one second register value from the at least one register value constituting said second register; and
an information value generation unit configured to generate an information value comprising a combination of the selected first register value and the selected second register value,
wherein said key generation unit generates the key based on the information value generated by said information value generation unit.

3. The encryption/decryption system according to claim 2, further comprising a combining unit configured to combine the information value with another information value.

4. The encryption/decryption system according to claim 3, wherein the other information value comprises plain text.

5. The encryption/decryption system according to claim 2, wherein said information value generation unit generates the information value when a first time period has elapsed and when a second time period has elapsed since startup of the encryption/decryption system.

6. The encryption/decryption system according to claim 5, wherein said key generation unit further comprises an arithmetic processing unit which performs arithmetic processing on the two information values, which are generated by said information value generation unit when the first time period has elapsed and the second time period has elapsed, by pseudo-randomizing each of the two information values.

7. The encryption/decryption system according to claim 6, wherein the arithmetic processing unit performs an exclusive-OR operation on the two information values.

8. The encryption/decryption system according to claim 2, wherein the encryption/decryption system is started in two ways, and
the information value varies according to the ways to start the encryption/decryption system.

9. The encryption/decryption system according to claim 2, wherein at least one of the register value of said first register and the register value of said second register varies with time.

10. A control method for an encryption/decryption system which sends and receives data to and from a host apparatus, comprising:
a storage step of storing, in encrypted form, a program for carrying out an encryption process or a decryption process on data sent and received to and from the host apparatus;
a key generation step of generating a key for decrypting the stored program in response to startup of the encryption/decryption system;
a decryption step of decrypting the stored program using the key generated in said key generation step; and
an execution step of executing the decrypted program.

11. A non-transitory computer-readable storage medium storing a program for causing a computer to execute a control method for an encryption/decryption system which sends and receives data to and from a host apparatus, the control method comprising:
a storage step of storing, in encrypted form, a program for carrying out an encryption process or a decryption process on data sent and received to and from the host apparatus;
a key generation step of generating a key for decrypting the stored program in response to startup of the encryption/decryption system;
a decryption step of decrypting the stored program using the key generated in the key generation step; and
an execution step of executing the decrypted program.
